(19) United States
(12) Patent Application Publication
(10) Pub. No.: US 2015/0156817 A1
(43) Pub. Date: Jun. 4, 2015

(54) MOBILE HOT SPOT

(71) Applicant: Cell Buddy Network Ltd., Tel Aviv (IL)

(72) Inventors: Ofir Paz, Rishon LeZion (IL); Yossi Dagan, Kfar Saba (IL); Erez Doron, Tel Aviv (IL); Robert Fleischer, Herzeliya (IL)

(21) Appl. No.: 14/406,226

(22) PCT Filed: Jun. 6, 2013
(86) PCT No.: PCT/IB2013/054669

§ 371 Date: Dec. 8, 2014

Related U.S. Application Data
(60) Provisional application No. 61/656,525, filed on Jun. 7, 2012.

(51) Int. Cl. H04W 88/08; H04W 8/22

(52) U.S. Cl. CPC H04W 88/08; H04W 8/22

(57) ABSTRACT

A portable wireless access point (My WAP) comprising: circuitry that supports wireless communication to and from the My WAP; a plurality of proxy-SIMs each configured to be assigned selectively any of a plurality of subscriber identity module (SIM) identities as an alias SIM identity; and a controller operable to assign an alias SIM identity to each proxy-SIM in the plurality of proxy-SIMs and control the proxy-SIM to use the alias SIM identity and the circuitry to establish a communication channel between a communication device connected to the My WAP and a cell-phone network.

### RELATED APPLICATIONS

The present application claims the benefit under 35 U.S.C. 119(e) of U.S. Provisional Application 61/656,525 filed on Jun. 7, 2012, the disclosure of which is incorporated herein by reference.

### FIELD

Embodiments of the invention relate to apparatus and methods of wireles sly connecting a communication terminal to a communication network.

### BACKGROUND

A hotspot is a wireless access point (WAP) comprising communication equipment, such as a transceiver or router, which may be accessed by a communication device over a wireless communication channel to connect the communication device to a local area network (LAN) and, usually, via the LAN to the Internet . Typically the transceiver or router operates in accordance with a wireless protocol, conventionally and popularly referred to as WiFi protocol, that conforms to one of the IEEE 802.11 family of standards and is connected to the LAN by an Ethernet channel. “WiFi hotspots” are ubiquitous and have been established in coffee shops, restaurants, hotels, airports, and retail establishments to provide Internet connectivity to most of today's common mobile communication devices, such as smart phones, tablet computers, and laptops.

Initially WiFi hotspots were stationary, fixed place installments. In May 2009, a United States company, “Novatel Wireless” introduced a hand held portable hotspot marketed under the trade name MiFi™ that can provide Internet access for up to five communication devices. Many of today's mobile communication devices, such as 3G mobile phones, laptops and notebooks are configured so that they may relatively easily be programmed to function as mobile hot spots.

### SUMMARY

An aspect of an embodiment of the invention relates to providing a personal, portable hotspot, which may be accessed by at least one mobile communication device to provide the communication device with a plurality of simultaneous, independently controllable communication channels to at least one cell-phone network.

For convenience of presentation a personal portable hotspot in accordance with an embodiment of the invention may be referred to as a personal, portable, wireless access point, a “MyWAP”. Any of the various communication devices that may connect to the MyWAP may in a given figure be generically represented by a particular communication device and be referred to by the particular communication device. For example, any of the communication devices may generically be shown and referred to as a cell-phone.

In accordance with an embodiment of the invention, a MyWAP comprises a different smart card for mediating each MyWAP communication channel to a cell-phone network that the MyWAP makes available to a communication device. Each smart card, hereinafter also referred to as a “proxy-SIM”, may be assigned an alias subscriber, or universal subscriber identity module (SIM or USIM) identity for use in accessing the cell-phone network. The alias identity may be borrowed selectively from any of a plurality of SIMs and/or USIMs, hereinafter generically referred to as SIMs, which may be made available by a “SIM server” comprising at least one SIM and generally a library of SIMs.

An alias SIM identity in accordance with an embodiment of the invention comprises a unique international mobile subscriber identity (IMSI) that identifies the SIM from which the alias identity is borrowed, and use of an identity authentication key (KI) associated with the IMSI. A SIM KI, is typically a 128 bit number that is usually not accessible from the SIM. When a communication device comprising the SIM attempts to access a cell-phone network it first submits its IMSI to the cell-phone network and in response receives an identity authentication challenge from the network. The SIM uses the KI to generate a response to the identity authentication challenge and if the response is correct the cell-phone network connects the cell-phone to the network.

In an embodiment of the invention, to assign an alias to a given proxy-SIM in a MyWAP, the MyWAP connects to a cell-phone network and transmits a request for an alias SIM identity to a SIM server via the cell-phone network. The request may include information that, optionally, comprises a location of the MyWAP and/or information relevant to establishing a MyWAP communication channel between the MyWAP and a called device. Information relevant to establishing the MyWAP channel may include a location of a cell-phone network base transceiver station (BTS) communicating with the MyWAP, and/or local time, and/or cell-phone networks and/or operators that are available to provide communication services to the MyWAP.

Upon receipt of the request, the SIM server determines if it has a SIM identity that may provide an alias SIM identity for the given proxy-SIM responsive to the information that provides advantageous pricing for services to be accessed by the MyWAP. If it has such a SIM identity, and it is available for lending to the MyWAP for use as an alias SIM identity, the SIM server transmits the SIM identity to the MyWAP. A controller in the MyWAP makes the SIM identity available as an alias to the given proxy-SIM to facilitate establishing a MyWAP channel between the proxy-SIM and the cell-phone network.

In an embodiment of the invention, the MyWAP comprises a multiplexing (MUX) and demultiplexing (DEMUX) module which may be implemented by suitable software and/or circuitry, hereinafter also referred to simply as a “MUX-DEMUX”. The MUX-DEMUX may parse transmissions from the at least one mobile communication device into segments and convey different segments transmission to the cell-phone network over different MyWAP communication channels provided by the MyWAP. The MUX-DEMUX, may multiplex segments it receives over the MyWAP channels for transmission to the at least one communication device. Optionally, the MyWAP comprises an encryption and decryption module, which may be implemented by suitable software and/or circuitry and uses the module to encrypt and/or decrypt data it transmits and/or receives over the MyWAP channels.

It is noted that “multiplex” or “MUX” may refer to conventional multiplexing in which portions of different messages are combined for transmission over a single communication channel, and/or to assembling a message from portions (segments) of the message that might have been transmitted from a source to a destination optionally via different communication channels. Similarly “demultiplexing” or “DEMUX” may refer to conventional demultiplexing, in which portions of different messages received in a same transmission over a same communication channel are separated for forwarding to different destinations, and/or to segmenting a message into portions (segments) for transmission optionally via different communication channels.

There is therefore provided in accordance with an embodiment of the invention a portable wireless access point (MyWAP) comprising: circuitry that supports wireless communication to and from the MyWAP; a plurality of proxy-SIMs each configured to be assigned selectively any of a plurality of subscriber identity module (SIM) identities as an alias SIM identity; and a controller operable to assign an alias SIM identity to each proxy-SIM in the plurality of proxy-SIMs and control the circuitry and the proxy-SIM to use the alias SIM identity to establish a communication channel between a communication device connected to the MyWAP and a cell-phone network. Optionally, the circuitry that supports wireless communication comprises dedicated circuitry for each proxy-SIM that supports wireless communications to and from the proxy-SIM.

In an embodiment of the invention, the controller is configured to transmit a request for a SIM identity for use as an alias SIM identity for assignment to a proxy-SIM of the plurality of proxy-SIMs from a SIM server comprising at least one SIM card having a SIM identity. Optionally, the request is transmitted to the SIM server via a cell-phone network.

In an embodiment of the invention, the request comprises information that characterizes a connection to be made by the communication device via the communication channel established by the proxy-SIM to another communication device accessible via the cell-phone network. Optionally, the information comprises at least one of, or any combination of, a location of a cell-phone network base station, local time at a location of the MyWAP, and/or identity of a cell-phone network and/or cell-phone network operator available to provide communication services to the MyWAP.

In an embodiment of the invention, the MyWAP comprises an encryption module operable to encrypt and decrypt communications that the MyWAP receives from, or transmits to the communication device or receives or transmits via a communication channel established using a proxy-SIM.

In an embodiment of the invention, the controller is configured to control the plurality of proxy-SIMs to establish and simultaneously maintain a plurality of communication channels, any two of which connect the communication device to a same cell-phone network or to different cell-phone networks. Optionally the MyWAP comprises a multiplexer operable to multiplex data received or transmitted by the MyWAP via the plurality of communication channels. Optionally the MyWAP comprises a demultiplexer operable to demultiplex communications received by the MyWAP to generate a communication for transmission to the communication device or via a communication channel established using a proxy-SIM of the plurality of proxy-SIMs.

In an embodiment of the invention, the controller controls the demultiplexer to parse information received from the communication device into segments, and routes different segments to different communication channels of the plurality of communication channels for transmission from the MyWAP. Optionally the controller controls the encryption module to encrypt the segments.

There is further provided in accordance with an embodiment of the invention communication system comprising: a MyWAP according to an embodiment of the invention; and a communication server connected to the Internet; wherein the controller controls the proxy-SIMs to establish a plurality of communication channels for communication with the communication server and the communication server transmits data to the MyWAP substantially simultaneously via each of the plurality of communication channels.

There is further provided in accordance with an embodiment of the invention a method of communicating via a cell-phone network the method comprising: providing a first communication device with wireless communication access to at least one proxy-SIM; assigning an alias SIM identity to the at least one proxy-SIM; controlling the at least one proxy-SIM to establish a communication channel to a cell-phone network; and connecting the first communication device to a second communication device that is accessible by the cell-phone network via the communication channel

Assigning an alias SIM identity optionally comprises accessing a SIM server having at least one SIM card and requesting a SIM identity from the SIM service for use as the alias SIM identity. Optionally, the at least one proxy-SIM comprises at least two proxy-SIMs, assigning a SIM identity to each of the at least two proxy-SIMs, and controlling each of the at least two proxy-SIMs to establish a communication channel to a same or a different cell-phone network. The method may comprise segmenting communications from the first device into segments and transmitting different segments to the second communication device via different communication channels of the communication channels established by the at least two proxy-SIMs. The method optionally comprises encrypting segments of the segments transmitted via different communication channels.

In the discussion, unless otherwise stated, adjectives such as “substantially” and “about” modifying a condition or relationship characteristic of a feature or features of an embodiment of the invention, are understood to mean that the condition or characteristic is defined to within tolerances that are acceptable for operation of the embodiment for an application for which it is intended. Unless otherwise indicated, the word “or” in the description and claims is considered to be the inclusive “or” rather than the exclusive or, and indicates at least one of, or any combination of items it conjoins.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF FIGURES

Non-limiting examples of embodiments of the invention are described below with reference to figures attached hereto that are listed following this paragraph. Identical features that appear in more than one figure are generally labeled with a same label in all the figures in which they appear. A label labeling an icon representing a given feature of an embodiment of the invention in a figure may be used to reference the given feature. Dimensions of features shown in the figures are chosen for convenience and clarity of presentation and are not necessarily shown to scale.

FIG. 1A schematically shows a MyWAP connected by a wireless channel to a cell-phone and operating to assign an alias SIM identity to a proxy-SIM and establish a MyWAP communication channel between the proxy-SIM and a mobile cell-phone network, in accordance with an embodiment of the invention;

FIG. 1B schematically shows the MyWAP shown in FIG. 1A after receiving an alias SIM identity from a SIM server and assigning the alias to a proxy-SIM in the MyWAP in accordance with an embodiment of the invention;

FIG. 1C schematically shows the MyWAP shown in FIG. 1B after the proxy-SIM has used the alias SIM identity to establish a MyWAP communication channel to the mobile cell-phone network, in accordance with an embodiment of the invention;

FIG. 2 schematically shows the MyWAP shown in FIGS. 1A-1C after having established a plurality of MyWAP channels to the mobile cell-phone network, in accordance with an embodiment of the invention; and

FIG. 3 schematically shows the MyWAP shown in FIG. 2 communication with a communication server to simultaneously receive segmented data via a plurality of MyWAP communication channels in accordance with an embodiment of the invention.

### DETAILED DESCRIPTION

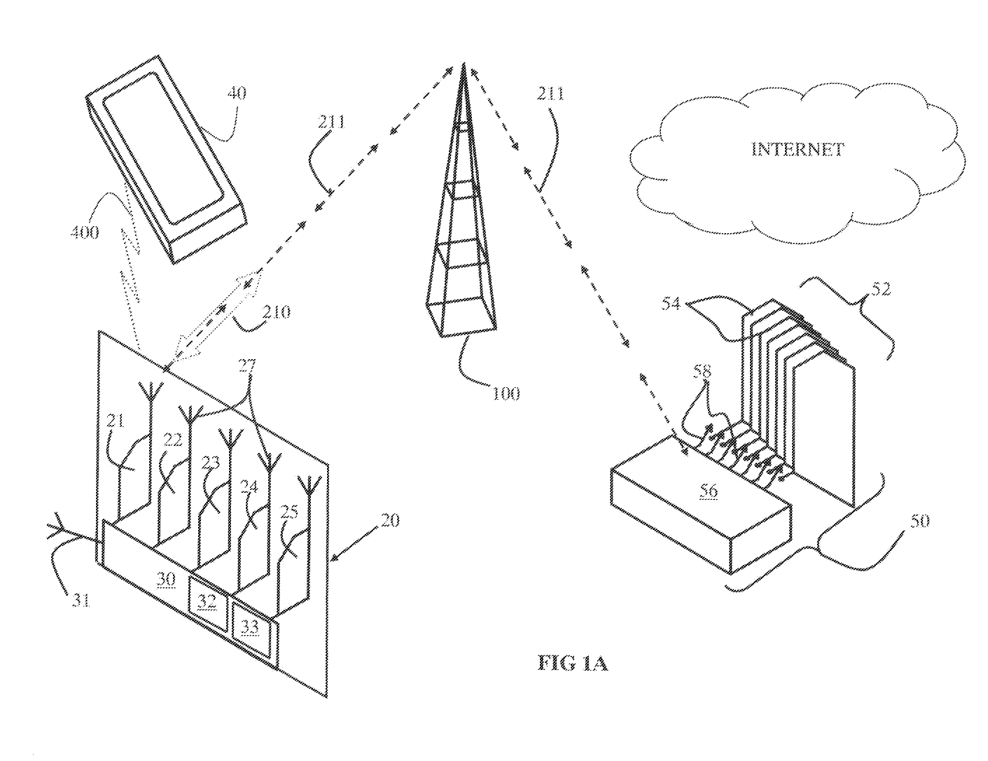

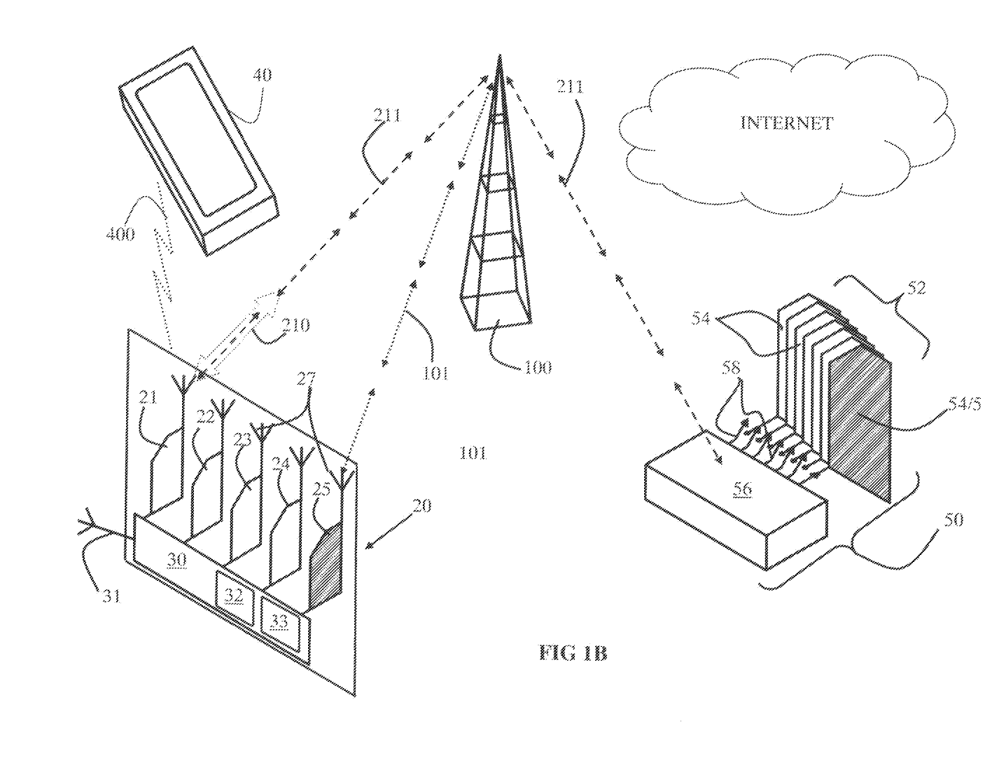

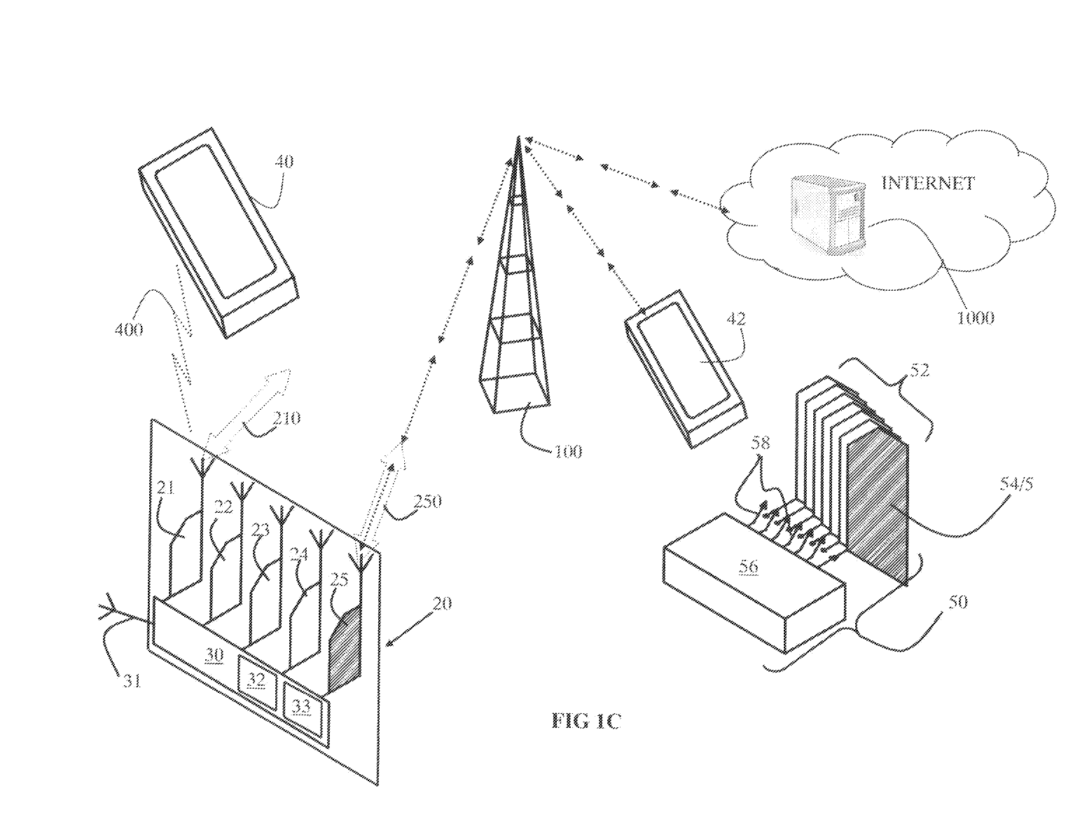

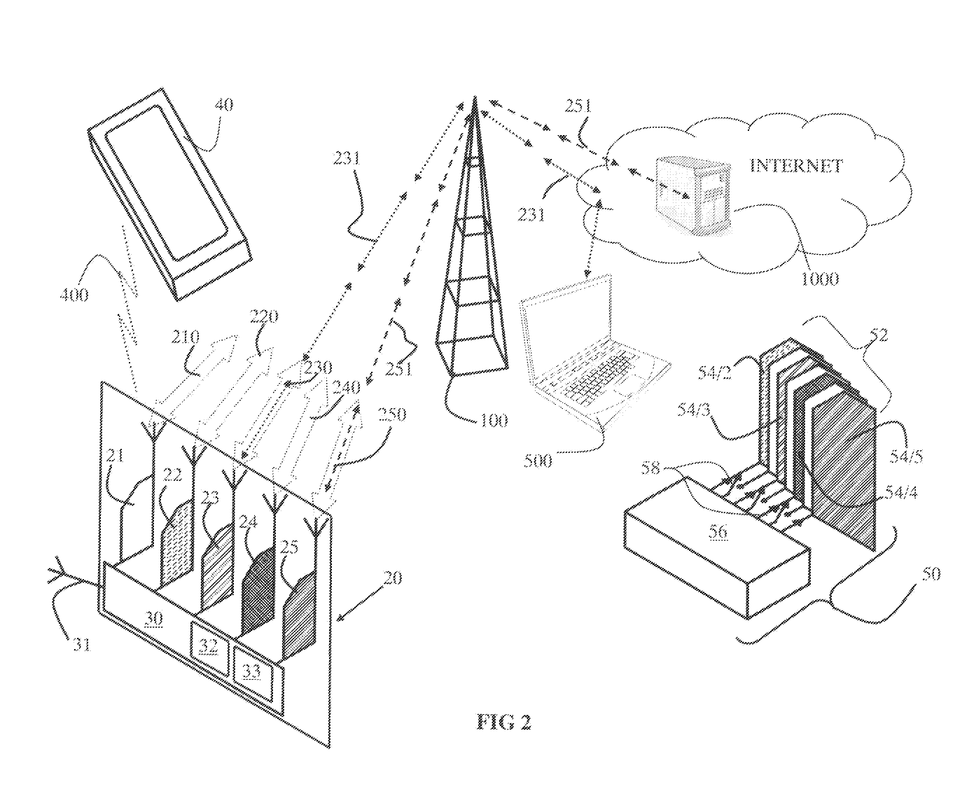

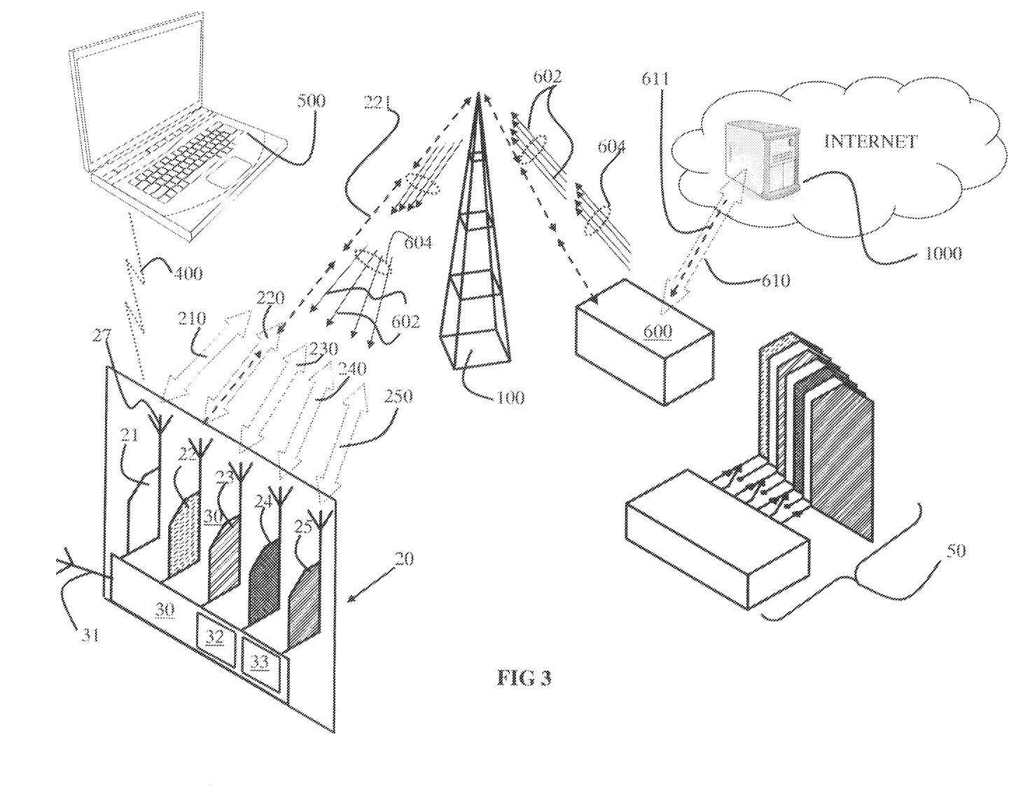

In the following detailed description, a MyWAP in accordance with an embodiment of the invention, and its operation in establishing a plurality of communication channels to a mobile cell-phone network by associating proxy-SIMs with alias SIM identities is described with reference to FIGS. 1A-1C and FIG. 2. A MyWAP may operate in accordance with an embodiment of the invention to transmit and receive data via a communications server that segments and encodes data in transmissions that it receives. By way of example, FIG. 3 schematically shows the MyWAP in the preceding figures receiving data from the Internet after the data has been segmented by a communications server and transmitted to the MyWAP over a plurality of MyWAP channels. Features of the MyWAP operating in conjunction with the communications server are discussed with reference to FIG. 3. In the detailed description, reference labels used to label icons representing features of embodiments of the invention may also be used to reference the features.

FIG. 1A schematically shows a MyWAP 20 optionally comprising a plurality of five proxy-SIMs, which may be in the format of SIM cards, labeled 21, 22, . . . 25, and a controller 30, in accordance with embodiment of the invention. Whereas MyWAP 20 is shown comprising five proxy-SIMs, practice of the invention is not limited to five proxy-SIMs and a MyWAP in accordance with an embodiment of the invention may have more or less than five proxy-SIMs. Optionally, each proxy-SIM 21, . . . , 25 is coupled to its own circuitry comprising an RF front end, transceiver, and/or other components, schematically represented by an antenna icon 27 and referred to as antenna 27, for supporting wireless communications to and from the proxy-SIM. In an embodiment of the invention, MyWAP 20 comprises at least one “independent” SIM and/or proxy-SIM having its own IMSI and KI to enable the MyWAP to establish a communication channel with a cell-phone network. By way of example, proxy-SIM 21 is assumed to be independent and comprises its own IMSI and KI. Controller 30 optionally comprises MUX-DEMUX module 32, also referred to as MUX-DEMUX 32 and an encryption module 33, for encrypting and decrypting communications that MyWAP 20 receives or transmits. Features of the operation of controller 30, MUX-DEMUX 32 and encryption module 33 are discussed below. It is noted that whereas MUX-DEMUX 32 and encryption module 33 are shown comprised in controller 30, the MUX-DEMUX and encryption module may be comprised in MyWAP 20 as modules separated from the controller. Optionally, controller 30 comprises its own RF front end, transceiver, and/or other components, schematically represented by an antenna icon 31 and referred to as antenna 31, for supporting wireless communications to and from the controller.

In FIG. 1A, a communication device, generically represented by a cell-phone 40, has contacted MyWAP 20 to request access to a cell-phone network, schematically represented by a communications tower 100, in order to establish communications with the Internet and/or other cell-phones (not shown in FIG. 1A). Cell-phone 40 may contact MyWAP 20 via a wireless or wire communication channel. In the scenario of FIG. 1 cell-phone 40 has contacted MyWAP 20 by a wireless channel schematically represented by a dotted “lightning” line 400. Wireless channel 400 may be established between cell-phone 40 and any of proxy-SIMs 21, . . . , 25, and/or circuitry (not shown), optionally included in controller 30, that is independent of the proxy-SIMs. By way of example, in FIG. 1A and figures that follow, wireless channel 400 is assumed established between cell-phone 40 and controller 30.

In response to receiving the request for access to a cell-phone network, controller 30 initiates a procedure to have proxy-SIM 21 connect to cell-phone network 100 and connect thereby MyWAP 20 to the cell-phone network. Proxy-SIM 21 uses its own IMSI and KI to open a communication channel, schematically represented by a double arrow head block arrow 210, to cell-phone network 100. Upon establishing communication channel 210, controller 30 optionally controls proxy-SIM 21 to acquire an alias SIM identity for use by one of proxy-SIMs 21, . . . 25, in establishing a communication channel to a cell-phone network, optionally cell-phone network 100.

In an embodiment, proxy-SIM 21 uses its established online channel to open a data link represented by dashed double arrowhead lines 211 to a SIM server 50 and place a request with the SIM server for an alias SIM identity. The request may comprise information as to where MyWAP 20 is located and/or a location of a network BTS communicating with MyWAP 20, and/or local time, and/or cell-phone networks and/or operators that are available to service MyWAP 20.

SIM server 50 optionally comprises a library 52 of SIMs, optionally in the format of SIM cards 54, and a processor 56. Processor 56 is able to select and communicate with any given SIM card of the plurality of SIM cards 54 to retrieve its IMSI, present it with an authentication challenge, and receive a response that the SIM card generates responsive to the authentication challenge. Switches 58 schematically represent the ability of processor 56 to select and communicate with any of SIM cards 54 comprised in library 52. When a switch 58 associated with a given SIM card 54 is closed, it graphically indicates the processor is in communication with the SIM card. Optionally, SIM server 50 is configured to communicate via cell-phone network 100 and comprises a dedicated SIM card (not shown), and/or selects a SIM card 54, for communication via the cell-phone network.

In response to receiving the request from proxy-SIM 21 for an alias SIM identity, processor 56 in SIM server 50 may respond by selecting a SIM card 54, arbitrarily distinguished by the label 54/5 and shown shaded in FIG. 1B, to provide an IMSI and associated KI for use by MyWAP 20 as an alias. After selecting SIM card 54/5 for providing the alias SIM identity, SIM server 50 transmits the IMSI of SIM card 54/5 to proxy-SIM 21 over data link 211. Proxy-SIM 21 transmits the received IMSI to controller 30, which optionally assigns the IMSI as an alias to proxy-SIM 25. In FIG. 1B proxy-SIM 25 is shaded similarly to SIM-card 54/5 to indicate that controller 30 has assigned the IMSI belonging to SIM card 54/5 to proxy-SIM 25.

Controller 30 uses proxy-SIM 25 to access cell-phone network 100 to present the network with its alias IMSI over a communication link represented by double arrowhead dotted lines 101. In response, cell-phone network 100 presents an authentication challenge to proxy-SIM 25, which in turn forwards the authentication challenge to controller 30. Controller 30 controls proxy-SIM 21 to transmit the authentication challenge to SIM-server 50 over data link 211.

Upon receiving the authentication challenge, processor 56 in the SIM server accesses SIM card 54/5 to provide an appropriate response to the authentication challenge using the SIM card's KI. The processor transmits the authentication challenge response provided by SIM card 54/5 to proxy-SIM 21 over data link 211. Proxy-SIM 21 forwards the response to controller 30, which provides the response to proxy-SIM 25 for submission to cell-phone network 100 over link 101. Upon receipt of the authentication response, cell-phone network 100 provides proxy-SIM 25 with a communication channel represented in FIG. 1C by a double arrowhead block arrow 250 for use in communicating via the network. Controller 30 may control proxy-SIM 25 to use communication channel 250 to cell-phone network 100 to make a connection to any of various communication devices that may be accessed via cell-phone network 100, such as a cell-phone 42 or a data server 1000 in the Internet.

In accordance with an embodiment of the invention, controller 30 operates to acquire alias SIM identities and communication channels to cell-phone network 100 for at least one additional proxy-SIM of the plurality of proxy-SIMs 21-24 similarly to the manner in which the controller operated to acquire a SIM identity and a communication channel for proxy-SIM 25. However, it should be noted that controller 30 does not have to revert to use of proxy-SIM 21 to acquire an alias SIM identity for the at least one additional proxy SIM. Any proxy-SIM 21-25 already connected to network 100 may be used to contact SIM server 50 via network 100 and acquire an alias IMSI and associated KI for another proxy-SIM that either does not have an alias SIM identity, or has an alias identity that is to be changed. For example, after channel 250 between proxy-SIM 25 and network 100 is established proxy-SIM 25 may be used to request an alias SIM identity for proxy-SIM 21.

FIG. 2 schematically shows MyWAP 20 after controller 30 has acquired an alias SIM identity from SIM server 50 for each of proxy-SIMs 22-24 from SIM cards 54 in library 52 distinguished by labels 54/2, 54/3, and 54/4 and the aliases and proxy-SIMs have been controlled to establish communication channels 220, 230, 240 to cell-phone network 100. In FIG. 2 each proxy-SIM 22-24 and its corresponding SIM card 54/2, 54/3, and 54/4 respectively from which it has received an alias SIM identity are shaded with a same distinctive shading different from the shading of other proxy-SIMS and their respective corresponding SIM cards.

It is noted that whereas in the above description an alias SIM identity was not acquired and assigned for proxy-SIM 21, in accordance with an embodiment of the invention an alias may be assigned also to proxy-SIM 21. It is also noted that whereas all proxy-SIMs 22-25 were assigned communication channels to a same cell-phone network 100, MyWAP is not constrained to establish communication channels with only one cell-phone network. Controller 30 may request an alias SIM identity for at least one of proxy SIMs 21, . . . , 25 that specifies a cell-phone network different from that for which aliases were requested for the other of the proxy-SIMs.

For example, controller 30 may determine that cell-phone network 100 is relatively congested, or that as the person using cell-phone 40 and MyWAP 20 roams about, that signal strength from cell-phone network is erratic. To maintain quality of service, controller 30 may decide to assign at least one of its proxy-SIMs an alias SIM identity advantageous for access to a cell-phone network or network provider different from cell-phone network 100 and/or the network provider of cell-phone network 100.

It is noted that a MyWAP in accordance with an embodiment of the invention is not limited to acquiring alias identities from any particular SIM server, and a SIM server is not required to be comprised in a single computer but may be based on a distributed computer system in which different computers comprise different components of the SIM server. The SIM server may for example be a cloud based SIM server with different functionalities of the SIM server distributed over the Internet. Additionally or alternatively MyWAP 20 may comprise its own library of SIM IDs for assignment to different proxy-SIMs in accordance with an embodiment of the invention.

After establishment of communication channels 220, 230, . . . 250, MyWAP 20 may use any of the communication channels for connecting cell-phone 40 to communication devices such as a laptop 500 or server 1000, that are accessible via cell-phone network 100, either via the Internet or exclusively via cell-phone network 100 and/or cell-phone networks connected to network 100. The MyWAP may also selectively use different communication channels of communication channels 210, 220, . . . 250 to substantially simultaneously connect the person using cell-phone 40 to different communication devices.

For example, controller 30 in MyWAP 20 may use communication channel 230 to establish a data line schematically indicated by dotted, double arrowhead, lines 231, optionally via the Internet , between cell-phone 40 and laptop 500 so that the person using cell-phone 40 can hold a video call with a person using the laptop. MyWAP 20 may establish a data link, represented by dashed double arrowhead lines 251 between the MyWAP and server 1000 in the Internet using communication channel 250, so that simultaneous with the conversation, the MyWAP may download files for the person using cell-phone 40 from the server. In an embodiment, MyWAP 20 comprises a memory (not shown) and controller 30 stores data downloaded from server 1000 in the memory and transmits the downloaded data optionally via antenna 31 of proxy-SIM 21 to cell-phone 40 over wireless channel 400.

In an embodiment of the invention controller 30 controls MUX-DEMUX module 32 to segment communications received from cell-phone 40 over wireless channel 400 and transmit different segments over different communication channels 210, 220, . . . , 250, to a destination communication device configured to multiplex segmented communications from MyWAP 20. Optionally, controller 30 encrypts the communications it transmits over communication channels 210, 220, . . . , 250. The segmented and encrypted transmissions make it relatively difficult for someone to intercept and eavesdrop on the transmissions.

In an embodiment of the invention, MyWAP 20 may have access to a communication server to support communications from and to cell-phone 40. The communication server may be configured to interface MyWAP 20 with various communication devices and perform communication management tasks that improve quality of service or enable functionalities additional to those provided by MyWAP 20. A communication server may for example function as an intermediate node for segmenting and/or encoding communication transmission from and to MyWAP 20.

By way of illustrative example, FIG. 3 schematically shows a laptop 500 that a user has connected to MyWAP 20 via a wireless channel 400 to request to download a relatively large data file, comprising for example, graphics, audio/visual (A/V) information, and/or data, from data server 1000 in the Internet. Responsive to the request for the file, MyWAP 20 used communication channel 220 to establish a data link, represented by dashed double arrowhead lines 221 to a communication server 600 and submit the request for the desired material to the communication server. With the request, MyWAP 20 has made available to communication server 600 communication channels 220, . . . , 250 for receiving the requested data at the MyWAP.

Communication server 600 maintains a fast communication channel, represented by a double arrowhead block arrow 610, to the Internet and has used the fast channel to forward the request from MyWAP 20 to data server 1000 and to establish a data link, represented by dashed double arrowhead line 611, to the data server for receiving the desired data file. In response, data server 1000 transmits the desired file to communication server 600.

Upon receipt of the data from the data server, to provide relatively rapid conveyance of the desired data file to MyWAP 20, communication server 600 establishes a plurality of data communication links with MyWAP 20 using communication channels 220, 230, 240 and 250, made available by the MyWAP. By way of example, it is assumed that communication server 600 has established four data communication links to MyWAP 20, one data communication link to each proxy SIMs 22, . . . , 25 using the proxy-SIMs respective communication channels 220, . . . , 250.

To transmit the data over the four data communication links communication server 600 segments the data received from data server 1000 and simultaneously transmits different segments of the data to MyWAP 20 via different data communication links established between the communication server and proxy-SIMs 22, . . . , 25. The simultaneous transmission of segments of the desired file to MyWAP 20 over the four data communication links are schematically represented by four arrows 602 bundled by a dashed loop 604.

Upon receipt of data segments from communication server 600, each proxy-SIM 22, . . . , 25 forwards the segments it receives to controller 30. The controller multiplexes the segments in proper sequence and transmits the multiplexed segments to laptop 500 via antenna 31.

Whereas in the above description server 600 segments, “demultiplexes”, the file data it receives from data server 1000 and controller 30 multiplexes the data, server 600 may transmit the data by dividing the file it receives from data server 1000 into portions and optionally substantially concurrently transmitting different portions of the file over different data links to MyWAP 20. Server 600 labels each portion of the file it transmits to MyWAP 20 by byte offsets of a beginning and an ending of the portion. Optionally, MyWAP 20 concatenates the portions in accordance with their byte offsets to reassemble the file transmitted by data server 1000 to server 600, and transmits the concatenated data to laptop 500. Optionally, MyWAP does not concatenate the portions and transmits the portions in random or otherwise in non-sequential order and laptop 500 concatenates the portions to assemble the data it receives into a complete coherent file.

It is noted that in the above description MyWAP 20 is shown connecting a single communication device to cell-phone network 100. However, MyWAP 20 may simultaneously connect a plurality of communication devices, optionally of different types, to cell-phone network 100. For example, MyWAP 20 may concurrently connect two cell-phones, a laptop and three notebooks to network 100.

In the description and claims of the present application, each of the verbs, “comprise”, “include” and “have”, and conjugates thereof, are used to indicate that the object or objects of the verb are not necessarily a complete listing of components, elements, or parts of the subject or subjects of the verb.

Descriptions of embodiments of the invention in the present application are provided by way of example and are not intended to limit the scope of the invention. The described embodiments comprise different features, not all of which are required in all embodiments of the invention. Some embodiments utilize only some of the features or possible combinations of the features. Variations of embodiments of the invention that are described, and embodiments of the invention comprising different combinations of features noted in the described embodiments, will occur to persons of the art. The scope of the invention is limited only by the claims.

1. A portable wireless access point (MyWAP) comprising:
circuitry that supports wireless communication to and from the MyWAP;
a plurality of proxy-SIMs each configured to be assigned selectively any of a plurality of subscriber identity module (SIM) identities as an alias SIM identity; and
a controller operable to assign an alias SIM identity to each proxy-SIM in the plurality of proxy-SIMs and control the circuitry and the proxy-SIM to use the alias SIM identity to establish a communication channel between a communication device connected to the MyWAP and a cell-phone network.

2. The MyWAP according to claim 1 wherein the circuitry that supports wireless communication comprises dedicated circuitry for each proxy-SIM that supports wireless communications to and from the proxy-SIM.

3. The MyWAP according to claim 1 wherein the controller is configured to transmit a request for a SIM identity for use as an alias SIM identity for assignment to a proxy-SIM of the plurality of proxy-SIMs from a SIM server comprising at least one SIM card having a SIM identity.

4. The MyWAP according to claim 3 wherein the request is transmitted to the SIM server via a cell-phone network.

5. The MyWAP according to claim 3 wherein the request comprises information that characterizes a connection to be made by the communication device via the communication channel established by the proxy-SIM to another communication device accessible via the cell-phone network.

6. The MyWAP according to claim 5 wherein the information comprises at least one of, or any combination of, a location of a cell-phone network base station, local time at a location of the MyWAP, and/or identity of a cell-phone network and/or cell-phone network operator available to provide communication services to the MyWAP.

7. The MyWAP according to claim 1 and comprising an encryption module operable to encrypt and decrypt communications that the MyWAP receives from, or transmits to the communication device or receives or transmits via a communication channel established using a proxy-SIM.

8. The MyWAP according to claim 1 wherein the controller is configured to control the plurality of proxy-SIMs to establish and simultaneously maintain a plurality of communication channels, any two of which connect the communication device to a same cell-phone network or to different cell-phone networks.

9. The MyWAP according to claim 8 and comprising a multiplexer operable to multiplex data received or transmitted by the MyWAP via the plurality of communication channels.

10. The MyWAP according to claim 8 and comprising a demultiplexer operable to demultiplex communications received by the MyWAP to generate a communication for transmission to the communication device or via a communication channel established using a proxy-SIM of the plurality of proxy-SIMs.

11. The MyWAP according to claim 10 wherein the controller controls the demultiplexer to parse information received from the communication device into segments, and routes different segments to different communication channels of the plurality of communication channels for transmission from the MyWAP.

12. The MyWAP according to claim 11 and comprising an encryption module that the controller controls to encrypt the segments.

13. A communication system comprising:
a MyWAP according to claim 1; and
a communication server connected to the Internet ;
wherein the controller controls the proxy-SIMs to establish a plurality of communication channels for communication with the communication server and the communication server transmits data to the MyWAP substantially simultaneously via each of the plurality of communication channels

14. A method of communicating via a cell-phone network the method comprising:
providing a first communication device with wireless communication access to at least one proxy-SIM;
assigning an alias SIM identity to the at least one proxy-SIM;
controlling the at least one proxy-SIM to establish a communication channel to a cell-phone network; and
connecting the first communication device to a second communication device that is accessible by the cell-phone network via the communication channel.

15. The method according to claim 14 wherein assigning an alias SIM identity comprises accessing a SIM server having at least one SIM card and requesting a SIM identity from the SIM service for use as the alias SIM identity.

16. The method according to claim 14 wherein the at least one proxy-SIM comprises at least two proxy-SIMs, assigning a SIM identity to each of the at least two proxy-SIMs, and controlling each of the at least two proxy-SIMs to establish a communication channel to a same or a different cell-phone network.

17. The method according to claim 16 and comprising segmenting communications from the first device into segments and transmitting different segments to the second communication device via different communication channels of the communication channels established by the at least two proxy-SIMs.

18. The method according to claim 17 and comprising encrypting segments of the segments transmitted via different communication channels.
